(19) United States
(12) Patent Application Publication
(10) Pub. No.: US 2016/0227737 A1
(43) Pub. Date: Aug. 11, 2016

(54) DEVICE AND METHOD FOR DISPENSING A PET TREAT

(71) Applicant: PetBot Inc., Ottawa (CA)

(72) Inventor: Michael DZAMBA, Mississauga (CA)

(73) Assignee: PetBot Inc., Ottawa (CA)

(21) Appl. No.: 15/015,884

(22) Filed: Feb. 4, 2016

Related U.S. Application Data
(60) Provisional application No. 62/112,357, filed on Feb. 5, 2015.

(51) Int. Cl. A01K 5/02; A01K 29/00

(52) U.S. Cl. CPC A01K 5/0225; A01K 29/005

(57) ABSTRACT

A device for remotely dispensing a pet treat is described. In one aspect, the device includes: a main housing having an outlet opening and a treat dispensing portion disposed in the interior of the main housing. The treat dispensing portion includes: a base; a dispensing chamber having a first opening; and a dispensing turbine configured to rotate horizontally within the dispensing chamber, the dispensing turbine including a turbine hub and at least one blade attached to a lateral surface of the turbine hub, wherein the first opening of the dispensing chamber is generally aligned with the outlet opening.

### CROSS REFERENCE TO RELATED APPLICATIONS

The present application claims priority to, and incorporates by reference, U.S. Provisional Patent Application Ser. No. 62/112,357, filed on Feb. 5, 2015 and owned in common herewith.

### FIELD

The present disclosure relates to pet treat dispensing and, in particular, to a device and method for remotely dispensing a pet treat.

### BACKGROUND

Pet owners who are away from their pets for prolonged periods of time have limited means for feeding, interacting with or generally checking up on their pets. It would be advantageous to provide devices for pet owners to use to remain connected with their pets even while they are away.

### BRIEF DESCRIPTION OF THE DRAWINGS

Reference will now be made, by way of example, to the accompanying drawings which show example embodiments of the present application, and in which:

FIG. 1 shows a perspective view of an example pet treat dispensing device, including a main housing and a camera, in accordance with example embodiments of the present disclosure.

FIG. 2 shows a perspective view of the interior of the main housing of FIG. 1.

FIG. 3 shows another perspective view of the interior of the main housing of FIG. 1.

FIG. 4 shows a perspective view of a dispensing turbine, a base and a dispensing chute, in accordance with example embodiments of the present disclosure.

FIG. 5 shows, in flowchart form, an example method for remotely interacting with a pet.

Like reference numerals are used in the drawings to denote like elements and features.

### DESCRIPTION OF EXAMPLE EMBODIMENTS

In accordance with one aspect, the present application describes a pet treat dispensing device. The device includes: a main housing having an outlet opening and a treat dispensing portion disposed in the interior of the main housing. The treat dispensing portion includes: a base; a dispensing chamber configured to rest on at least a portion of the base, the dispensing chamber having a first opening; and a dispensing turbine configured to rotate horizontally within the dispensing chamber, the dispensing turbine including: a turbine hub; and at least one blade attached to a lateral surface of the turbine hub, wherein the first opening of the dispensing chamber is generally aligned with the outlet opening.

In accordance with another aspect, the present application describes a method for dispensing a pet treat. The method includes: providing a pet treat dispensing device including a camera; capturing a first image using the camera; based on the first image, determining that a pet is within a field of view of the camera; in response to determining that the pet is within the field of view of the camera, causing the pet treat dispensing device to provide an audible signal to summon the pet and starting capture of camera data using the camera; based on the camera data, determining that a first condition is satisfied and in response to determining that the first condition is satisfied, causing the pet treat dispensing device to dispense a treat and halting capture of camera data.

Other example embodiments of the present disclosure will be apparent to those of ordinary skill in the art from a review of the following detailed description in conjunction with the drawings.

### Example Device For Dispensing a Pet Treat

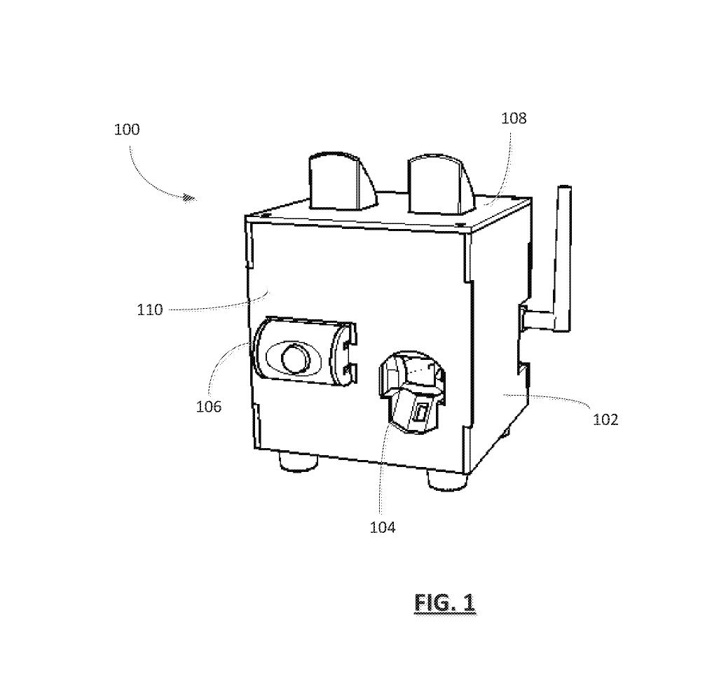

Reference is now made to FIG. 1, which shows a perspective view of an example pet treat dispensing device 100. It will be understood that the pet treat dispensing device 100 may be used to dispense treats to numerous different types of pets including, but not limited to, dogs and cats. Furthermore, the pet treat dispensing device 100 can be deployed at home, a pet care facility or wherever a pet resides. The pet treat dispensing device 100 can be used and controlled by a user regardless of where the user is located.

The pet treat dispensing device 100 includes a main housing 102. The main housing 102 can have various shapes. For example, in the embodiment shown in FIG. 1, the main housing 102 has a generally cubic shape. The walls of the main housing 102 define an outer surface and an interior space (not shown in FIG. 1). In some embodiments, the main housing 102 has a front wall 110 and a rear wall. The front wall 110 is a wall of the main housing which may be faced towards a pet when the pet treat dispensing device 100 is in use. The rear wall is a wall of the main housing that is opposite the front wall 110.

The main housing 102 has an outlet opening 104 for dispensing a pet treat. In the example of FIG. 1, the outlet opening 104 is positioned on the outer surface of the front wall 110. The outlet opening 104 may be sized to accommodate pet treats of various shapes and sizes. In some embodiments, the main housing 102 may include a movable cover for the outlet opening 104 such that the size of the opening can be adjusted.

In at least some embodiments, the main housing 102 also includes a camera 106. As shown in FIG. 1, the camera 106 may be coupled to the main housing 102 and positioned on the outer surface of the front wall 110. For example, the camera 106 may be positioned adjacent to the outlet opening 104. In some other embodiments, the camera 106 can be mounted on a top surface of the main housing 102. The camera 106 may also be removable from the main housing 102 or may be embedded in a wall of the main housing 102.

The camera 106 is configured to generate camera data, such as images in the form of still photographs and motion videos. The camera data may be captured in the form of an electronic signal which is produced by an image sensor associated with the camera 106. That is, the image sensor converts an optical image into an electronic signal, which may be output from the image sensor by way of one or more electrical connectors associated with the image sensor. The electronic signal represents electronic image data or camera data.

In at least some embodiments, the camera 106 may be capable of wireless communication. For example, the camera 106 may be an Internet protocol (IP) camera. An Internet protocol camera can send and receive data via a communication network. In some embodiments, the camera 106 may be able to upload data to a remote server or directly transmit data to a remote electronic device via a communication network. For example, the camera 106 may establish a connection, using Ethernet or Wi-Fi, to a server and transmit camera data captured by the camera 106 to the server. Other types of cameras may be used in the pet treat dispensing device 100. For example, the camera 106 can be a webcam connected by USB cable to a computing device.

In some embodiments, the camera 106 may be coupled to an on-board processor in the pet treat dispensing device 100. That is, the camera 106 may be connected to or be configured to communicate directly with a processor located in the pet treat dispensing device 100. An on-board processor of the pet treat dispensing device 100 may be a central processing unit (CPU) or a graphics processing unit (GPU). In some embodiments, the on-board processor may be a processor on a single-board computer, such as the RASPBERRY PI™. In at least some embodiments, the processor of the pet treat dispensing device 100 may be coupled to a wireless receiver and transmitter. In particular, the pet treat dispensing device 100 may have a communication subsystem, coupled to the processor, for sending data to and receiving data from a wireless communication network.

In some embodiments, the main housing 102 may be mountable on a wall in a room. For example, the rear wall of the main housing 102 may have one or more mounting mechanisms for mounting the pet treat dispensing device 100 on a docking support affixed to a wall of a room. In at least some embodiments, the main housing 102 may have a removable lid 108. For example, as shown in FIG. 1, a top wall of the main housing 102 may be detached from the main housing 102 and serve as the removable lid 108. The lid 108 may be mounted on the main housing 102 by a hinge assembly. The lid 108 may also have one or more handles located thereon.

The main housing 102 may also include one or more openings for loading pet treats into the pet treat dispensing device 100. In some embodiments, the lid 108 may be removed such that pet treats can be loaded into the interior space of the main housing 102. In other embodiments, there may be one or more openings on a wall of the main housing 102 for inserting pet treats into the interior space of the main housing 102.

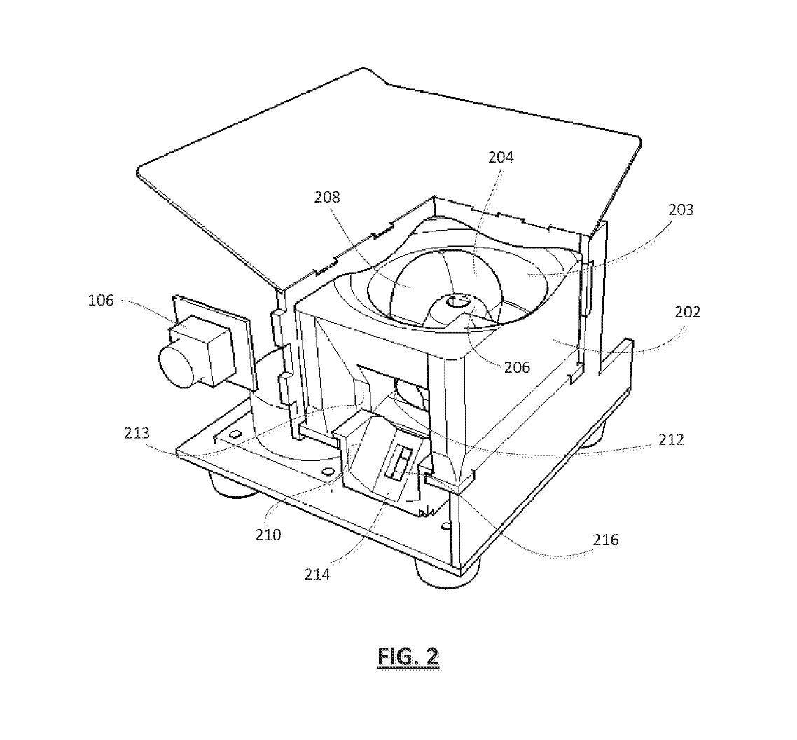

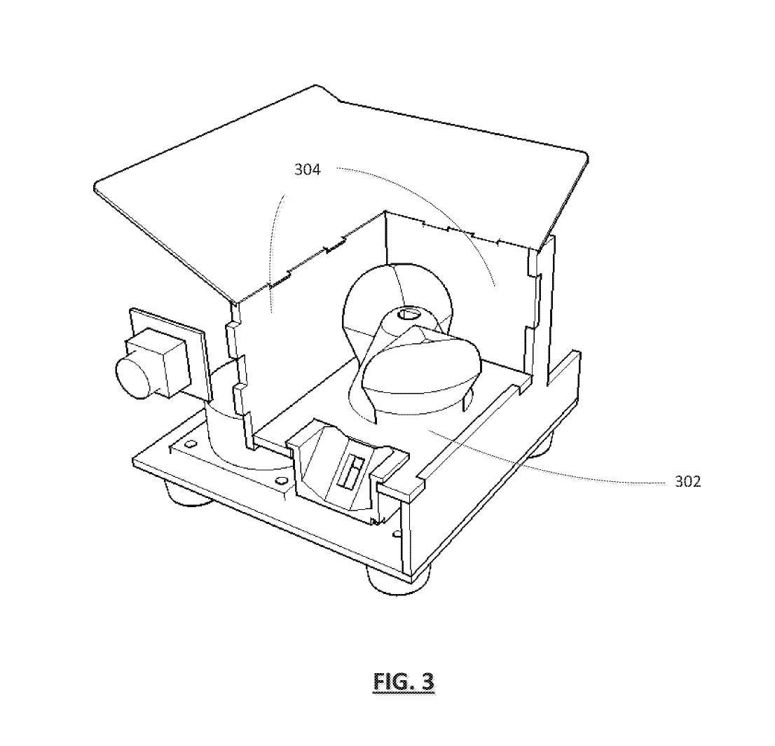

Reference is now made to FIGS. 2 and 3, which show perspective views of the interior of the main housing 102 of FIG. 1. The pet treat dispensing device 100 includes a treat dispensing portion disposed in the interior of the main housing 102. The treat dispensing portion includes a base 302, a dispensing chamber 202 and a dispensing turbine 204. As illustrated in FIG. 3, the base 302 comprises a flat horizontal surface in the interior of the main housing 102. The dispensing chamber 202 is configured to rest on at least a portion of the base 302. In at least some embodiments, the main housing 102 may have one or more interior side walls 304 defining a cavity that is shaped to receive the dispensing chamber 202. In FIG. 3, the base 302 and perpendicular side walls 304 define a box-shaped cavity for receiving the dispensing chamber 202.

The dispensing chamber 202 may be box-shaped and, specifically, the dispensing chamber 202 may have a cube shape. Alternatively, the dispensing chamber 202 may have a different shape, such as a cylinder or a sphere. The height of the dispensing chamber 202 is less than the height of the main housing 202. In at least some embodiments, the dispensing chamber 202 may be positioned adjacent to the inner surface of the front wall 110 (in FIG. 1) of the main housing 102. For example, the dispensing chamber 202 may sit in the interior of the main housing 102 such that it abuts and makes contact with the front wall 110. The dispensing chamber 202 may be removable from the main housing 102, or it may be fixedly secured to the base 302 or a wall of the main housing 102.

In at least some embodiments, the dispensing chamber 202 has a bore 203 extending between a top surface of the dispensing chamber 202 and a bottom surface of the dispensing chamber 202. The bore 203 of the dispensing chamber 202 is adapted to receive pet treats when they are loaded into the pet treat dispensing device 100 before the treats can be dispensed. The bore 203 may be generally centrally located within the dispensing chamber 202. In some embodiments, the bore 203 has a cylindrical shape. The bore 203 has an open top end, allowing treats to be dropped into the bore 203. In at least some embodiments, the cross-sectional area of the bore 203 may vary along the height of the bore 203. In particular, the cross-sectional area of the top end of the bore 203 may be different from the cross-sectional area of the bottom end of the bore 203. For example, the cross-sectional area of the bore 203 may decrease from the top end of the bore 203 to the bottom end of the bore 203.

In some embodiments, the dispensing chamber 202 has a first opening 212. The first opening 212 may extend between the wall of the bore 203 and an outer surface of the dispensing chamber 202. For example, the first opening 212 may be a bore passage that extends between the wall of the bore 203 and the outer surface of a front wall 213 of the dispensing chamber 202. The front wall 213 of the dispensing chamber 202 is a wall of the dispensing chamber 202 that is on the same side of the main housing 102 as the front wall 110 when the dispensing chamber 202 is disposed in the interior of the main housing 102. Like the front wall 110 of the main housing 102, the front wall 213 of the dispensing chamber 202 faces towards a pet when the pet treat dispensing device 100 is in use. In at least some embodiments, the first opening 212 of the dispensing chamber 202 may be aligned with the outlet opening 104 of the main housing. The first opening 212 provides an outlet through which pet treats can be ejected from inside the bore 203. In other words, pet treats can be moved from within the bore 203 and out of the dispensing chamber 202 through the first opening 212. In some embodiments, the first opening 212 may be positioned on the lower end of the wall of the bore 203 such that pet treats can be pushed out through the lower end of the dispensing chamber 202. In the example of FIG. 2, the first opening 212 is rectangular and is positioned on the lower end of the front wall of the dispensing chamber 202. In other embodiments, the size and shape of the first opening 212 can be different from the example shown in FIG. 2, in order to accommodate a wider range of pet treats.

FIG. 2 shows a dispensing turbine 204 positioned inside the bore 203. In at least some embodiments, the dispensing turbine 204 is configured to rotate horizontally within the bore 203. The dispensing turbine 203 includes a turbine hub 206 and at least one blade 208 coupled to a lateral surface of the turbine hub 206. When the dispensing turbine 204 rests inside the bore 203, the turbine hub 206 may be centrally positioned with respect to the bore 203. In at least some embodiments, the turbine hub 206 may be cone-shaped. FIG. 2 shows an example of a cone-shaped turbine hub 206. In FIG. 2, the turbine hub 206 has a slanted lateral side and a flat base. In some embodiments, the flat base may have a diameter which is substantially equal to the diameter of the bottom end of the bore 203. That is, the flat base of the turbine hub 206 may fit the bottom end of the bore 203 closely. In other embodiments, the turbine hub 206 may have a different shape. For example, the turbine hub 206 may be a cylinder.

In at least some embodiments, the at least one blade 208 is sized to fit between the lateral surface of the turbine hub 206 and the wall of the bore 203. As illustrated in FIG. 2, the entire dispensing turbine 204, which includes the turbine hub 206 and at least one blade 208 coupled to the turbine hub 206, is configured to fit and rotate inside the bore 203. In some embodiments, the radial length of the at least one blade 208 may be substantially equal to the annular space between the turbine hub 206 and the wall of the bore 203. In other words, the at least one blade may extend substantially from the lateral surface of the turbine hub 206 to the wall of the bore 203. The blades 208 may be a projection extending radially outward from the lateral surface of the turbine hub 206. In some cases, the width of the projection may increase in a radial direction towards the wall of the bore 203. In some cases, the height of the at least one blade may increase in a radial direction towards the wall of the bore 203.

A dispensing chute 210 is shown in FIG. 2. In at least some embodiments, the dispensing chute 210 has a first end, a second end and a ramp 214 extending between the first end and the second end. The first end of the dispensing chute 210 may be in communication with the first opening 212 of the dispensing chamber 202. In the example of FIG. 2, the first end of the dispensing chute 210 is positioned near the first opening 212 and is at a higher elevation than the second end of the dispensing chute 210. In the illustrated example, the ramp 214 is inclined downward from the first end of the dispensing chute 210 to the second end of the dispensing chute 210. In some embodiments, the second end of the dispensing chute 210 may be in communication with the outlet opening 104 of the main housing 102. According to such embodiments, pet treats that are ejected from the first opening 212 of the dispensing chamber 202 can traverse down the inclined ramp 214 of the dispensing chute 210 and exit the main housing 102 by the second end of the dispensing chute.

In at least some embodiments, one or more infrared sensors 216 may be positioned on a top surface of the ramp 214 of the dispensing chute 210. For example, the infrared sensors 216 may be infrared reflectance sensors, containing a matched light-emitting diode (LED) emitter and infrared detector pair. Infrared reflectance sensors operate by measuring an amount of infrared radiation transmitted by the emitter that is reflected into the detector. The infrared sensors 216 may be configured for remote control and touch-less object sensing. By continuously transmitting infrared radiation from the emitter, when an object, such as a pet treat, passes over the infrared sensors 216, the emitted infrared radiation may be reflected and detected by the detector. The detector may generate an electronic signal having a magnitude proportional to the intensity of the received reflected infrared radiation, and readings from the detector may be collected by, for example, using an analog-to-digital converter coupled to an on-board processor to convert analog electronic signals to digital signals appropriate for further signal processing. In the pet treat dispensing device 100, the readings from the detector can be monitored in real-time to determine whether pet treats have been successfully dispensed from the main housing 102. In at least some embodiments, the infrared emitter and infrared detector may be positioned side-by-side on the ramp 214, separated by a fixed distance between each other.

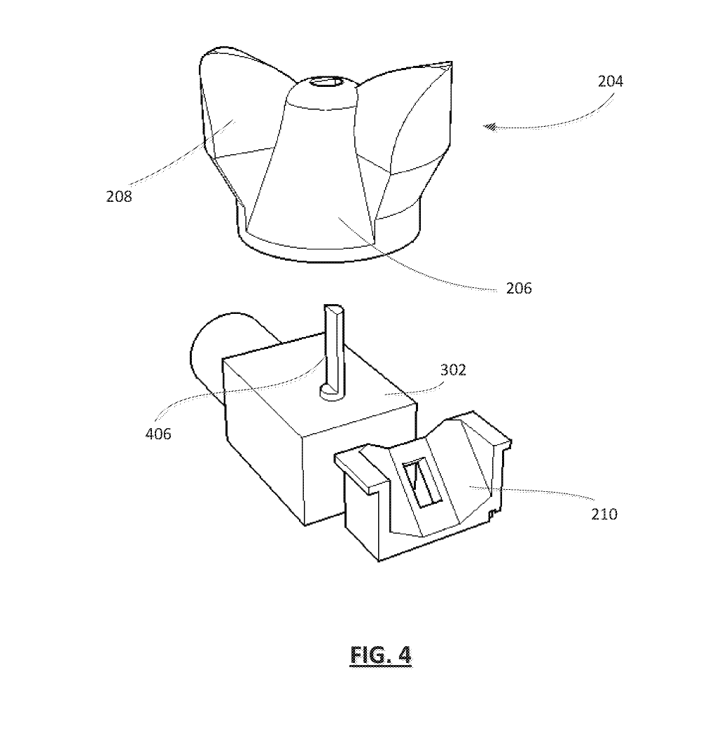

Reference is now made to FIG. 4, which shows the dispensing turbine 204, the base 302 and the dispensing chute 210 in isolation from each other. In at least some embodiments, the base 302 has a vertical shaft 406 positioned on the top surface. In the example of FIG. 4, the vertical shaft 406 has a fixed height and is rotatable with respect to the base 302. The turbine hub 206 in FIG. 4 has an axial bore 410 (not shown) extending upward from the bottom surface of the turbine hub 206, the axial bore 410 being sized to fit over the vertical shaft 406. That is, the dispensing turbine 204 can rest on the base 302 by fitting the axial bore 410 over the vertical shaft 406. In some other embodiments, the base 302 may not have a vertical shaft and may instead have a different rotating member that can be attached to the dispensing turbine 204. For example, the base 302 may have a rotatable plate positioned on the top surface. In such example, the turbine hub 206 may have a groove defined on the bottom surface to fit over and be secured to the rotatable plate. Other mechanisms for rotatably attaching the dispensing turbine 204 to the base 302 may be used in the pet treat dispensing device 100.

In the example shown in FIG. 4, rotation of the dispensing turbine 204 is caused by rotation of the vertical shaft 406 with respect to the base when the turbine hub 206 is fit over the vertical shaft 406. The rotation of the vertical shaft 406 may, in turn, be driven by an electric motor. In some embodiments, the vertical shaft 406 may be coupled to a servo motor. The servo motor may be either an alternating current (AC) motor or a direct current (DC) motor. In other embodiments, a stepper motor may be used. The electric motor may have an associated motor control circuit electronics portion, separate from the electric motor, and both the electric motor and the motor control circuit electronics portion may be located beneath the top surface of the base 302. Alternatively, the motor control mechanism, including one or more gears, positional sensors and circuit board electronics components, may be built-in to the electric motor. In at least some embodiments, the electric motor and motor control mechanism may be coupled to an on-board processor located in the pet treat dispensing device 100.

### Example Method of Remotely Interacting With a Pet

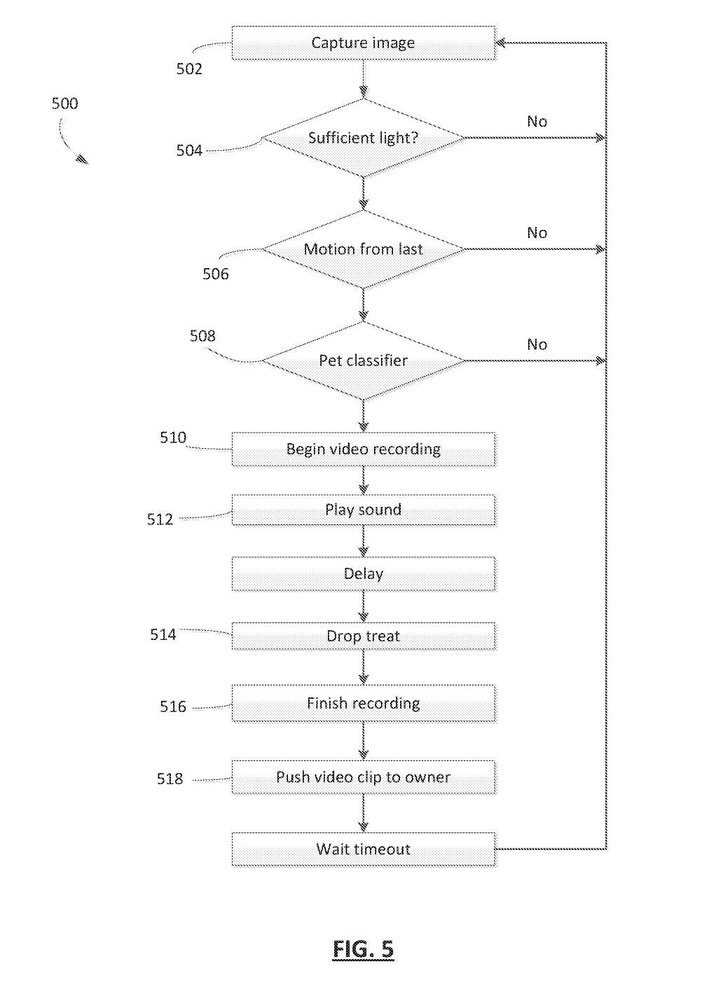

Reference will now be made to FIG. 5, which shows, in flowchart form, an example method 500 of remotely interacting with a pet. The method 500 can be performed partly by the pet treat dispensing device 100 and partly by a user remotely controlling the pet treat dispensing device 100 via an electronic device.

A first image is captured by the camera 106 at operation 502. The first image may be automatically captured, either periodically or at fixed times throughout a day. Alternatively, the first image may be captured in response to a command transmitted from a remote user. As described above, the camera 106 may be coupled to an on-board processor in the pet treat dispensing device 100. The processor may be coupled to an on-board memory. In at least some embodiments, the processor may also be configured to receive and send data via a communications subsystem of the pet treat dispensing device 100, by establishing a connection to a wireless network, for example, using Ethernet or Wi-Fi technology. In this way, the processor of the pet treat dispensing device 100 can communicate with a remote network or device. For example, camera data captured by the camera 106 may be sent to a remote user either by using a communication functionality of the camera 106 or by first receiving the camera data at the processor and subsequently uploading the camera data to a wireless network. In at least some embodiments, a user may be able transmit commands to the processor of the pet treat dispensing device 100 via an application on a mobile electronic device, such as a smartphone. In some other embodiments, a user may access a web interface or a software program on a computing device to transmit commands to the processor of the pet treat dispensing device 100.

Once the first image has been captured by the camera 106, the processor of the pet treat dispensing device 100 determines, at operation 504, whether there is sufficient light in the captured first image. In some embodiments, the processor may execute an image processing algorithm to determine a brightness of a raw digital image captured by the camera 106. For example, the processor may compute an average brightness of all pixels in the captured first image. The image brightness value of the first image can then be compared to a predefined threshold to determine whether the first image is sufficiently bright. In some embodiments, the processor may be configured to execute a brightness compensation program on the first image to adjust the brightness of the image.

At operation 506, the processor of the pet treat dispensing device 100 may compare the first image to a second image previously captured by the camera 106 and stored in the memory coupled to the processor, to determine whether local motion has occurred in the first image based on the comparison. In some embodiments, values of a plurality of pixels at corresponding pixel locations in the first image and the second image may be compared and the differences in the pixel values can be calculated. The difference values may then be compared to a predefined threshold to detect if there has been local motion between the image frames.

If there is sufficient brightness and local motion has been detected in the first image, the method 500 proceeds to determine, based on the first image, whether a pet is detected within a field of view of the camera 106. The field of view of the camera 106 can be the entire field of view of the camera 106 or a sub-region of the field of view. In some embodiments, the processor of the pet treat dispensing device 100 may execute one or more computer vision and pattern recognition algorithms to determine whether a pet is within the field of view of the camera 106. By way of illustration and not limitation, a pre-trained convolutional neural network can be used for visually recognizing a type of pet, such as a dog or cat, or a specific pet. Based on a classification of the first image by the neural network, the first image may be considered to include a pet within a field of view of the camera. For example, if the pre-trained model is configured to generate outputs as probabilities, the first image may be determined to correspond to a pet if execution of the model on the first image outputs a probability, greater than a pre-defined threshold value, that a subject in the first image is a pet. In some cases, the threshold value may be adjusted by a user in order to capture a wider range of pet-liked images. In other embodiments, different visual recognition algorithms may be implemented on the processor of the pet treat dispensing device 100 to locally determine whether a pet is within a field of view of the camera 106.

If a pet is detected at operation 508, the camera 106 begins capturing camera data. In some embodiments, the processor of the pet treat dispensing device 100 may be configured to automatically activate the camera 106 upon determining that a pet is detected within a field of view of the camera 106. In other embodiments, a message can be sent a remote user to indicate that the camera 106 has detected a pet and the user can subsequently transmit a command to activate the camera 106. The camera data can be image data or video data. The capture of the camera data can be timed or a user can remotely control a duration for which camera data is captured.

At operation 512 of the method 500, the pet treat dispensing device 100 may be configured to provide an audible signal to summon a pet. In at least some embodiments, the processor of the device 100 may cause a pre-recorded sound, such as a tune or an owner's voice, to be played through a built-in speaker in the pet treat dispensing device 100. For example, the pre-recorded sound can be a sound that is audible to the pet or a sound with which the pet may already be familiar. In other embodiments, a remote user may be able to communicate directly with the pet by speaking into a microphone in an electronic device and causing the voice data to be transmitted to the pet treat dispensing device 100 to be played to the pet. For example, a remote user can speak into the microphone on a mobile phone and use an application on the mobile phone to send the voice communication, in real-time, to the pet treat dispensing device 100.

After providing an audible signal from the pet treat dispensing device 100, the processor of the device 100 determines whether a first condition is satisfied, based on the camera data. In some embodiments, the pet treat dispensing device 100 may have one or more sensors in the main housing 102 that are coupled to the processor, the sensors being configured to determine a proximity of a pet to the pet treat dispensing device 100. If the one or more sensors indicate that a pet is within a predetermined distance of the pet treat dispensing device 100, the first condition will be satisfied. In other embodiments, a remote user may view the camera data from the camera 106 in real-time and transmit a command to the pet treat dispensing device 100 that the first condition is satisfied. For example, the user may provide a voice command to the pet through a built-in speaker on the pet treat dispensing device 100 and upon visually verifying that the pet has performed a specific action, the user can signal to the processor of the pet treat dispensing device 100 (via a mobile application, for example) that the first condition is satisfied. In some embodiments, the first condition will be satisfied when it is determined that the pet is performing a specific pose in front of the pet treat dispensing device 100. Using the camera 106, camera data can be captured of the pet when the pet is in the field of view of the camera 106. A convolutional neural network can be pre-trained to recognize specific poses that the pet may perform. For example, the pet owner may train the pet to sit on all four legs or to sit on just the pet's hind legs, and the neural network can be pre-trained to recognize these poses. The pre-trained neural network can be implemented in a processor of the pet treat dispensing device 100 and based on the captured camera data, if certain predefined poses or actions are recognized by the neural network model, the first condition will be satisfied. In yet further embodiments, the first condition may be satisfied by other mechanisms.

In response to determining that the first condition is satisfied, the processor of the pet treat dispensing device 100 causes the device 100 to dispense a treat at operation 514. In at least some embodiments, the processor may directly control an electric motor connected to the vertical shaft 406 of FIG. 4 to cause the vertical shaft 406 and the dispensing turbine 206, fitted over the vertical shaft 406, to rotate horizontally. As in the example of FIG. 2, rotation of the dispensing turbine 206 within the dispensing chamber 202 will cause pet treats stored in the bore 203 to be dispensed through the first opening 212 of the dispensing chamber 212. In some other embodiments, a remote user may control a motor control circuit coupled to the electric motor to cause the dispensing turbine 206 to rotate within the dispensing chamber 202. For example, a remote user may use a mobile application to wirelessly transmit a command to the processor of the device 100 to dispense treats. Such command, when received by the processor, may cause the processor to control the electric motor, via motor control circuitry, to actuate a rotating member on the base 302, such as the vertical shaft 406 of FIG. 4.

The processor of the device 100 may be in persistent communication with the infrared sensors 216 of FIG. 2. After causing rotation of the dispensing turbine 206, the processor may monitor readings from the infrared sensors 216 (specifically, the infrared detector) to determine whether treats have been properly dispensed by the device 100. Based upon the infrared sensor data, if it is determined that a treat has been dispensed, rotation of the dispensing turbine 206 will be halted. Alternatively, if a stepper motor is used as the electric motor controlling rotation of the dispensing turbine 206, a full rotation may be divided into a number of equal steps and the motor's position can be controlled to move and hold at one of these steps without any feedback from the infrared sensors 216.

If, during rotation of the dispensing turbine 206, a jam is detected, the electric motor of the device 100 may be controlled to cause rotation of the dispensing turbine 206 in an opposite direction. In at least some embodiments, a jam of the dispensing turbine 206 may be detected by monitoring a level of current drawn by the electric motor of the device 100. For example, the device 100 may include a current sensing circuit, coupled to the processor of the device 100, configured to monitor a level of current provided to the electric motor in rotating the dispensing turbine 206. By way of illustration, a servo motor, when jammed, will apply full current while it attempts to move as commanded, usually resulting in a current level that is much higher than levels during normal operation of the motor. If the level of current drawn by the electric motor exceeds a pre-defined threshold, a jam of the dispensing turbine 206 is determined to have occurred. In some embodiments, a jam of the dispensing turbine 206 may be detected by determining the angular position of a shaft of the electric motor. When the electric motor is unable to produce rotational motion as a result of a jam of the dispensing turbine 206, the shaft of the electric motor will not move even when the electric motor is activated. By monitoring the angular position or motion of the motor shaft, then, it may be possible to determine whether a jam has occurred. In some cases, a rotary encoder may be used to track the angular position of the motor shaft. The rotary encoder may be either an optical encoder or a magnetic encoder.

Once a jam of the dispensing turbine 206 is detected, the dispensing turbine 206 may then be rotated in an opposite direction to try to dislodge a treat causing the jam. During this jam detection and resolution operation, the level of current drawn by the electric motor is continuously monitored. Each significant increase in the level of current may indicate that the dispensing turbine 206 is stuck in its current direction of rotation. As a result, with each such significant increase, the rotation of direction of the dispensing turbine 206 may be reversed. For example, if the level of current drawn by the electric motor increases above a threshold level, a reverse rotation of the dispensing turbine 206 may be produced. In some embodiments, the speed of rotation of the dispensing turbine 206 may be increased each time direction of rotation is reversed, such that increased force can be applied to a jammed treat to try to dislodge it or break it into smaller pieces that can be released from the jam. In some embodiments, each time that a jam is detected and a reverse rotation of the dispensing turbine 206 is produced, the threshold current level for detecting the next jam can be increased. That is, with each reverse rotation of the dispensing turbine 206, the level of current drawn by the electric motor may be allowed to increase to a higher level or the length of time for which the electric motor draws maximum current may be allowed to increase. This way, it may be possible for the electric motor to apply more rotational power to the dispensing turbine 206 with each successive detected jam, in order to cause the jammed treats to be dislodged or broken.

Additionally, in at least some embodiments, the captured camera data may be stored in a memory of the pet treat dispensing device 100. In other embodiments, the captured camera data may be transmitted wirelessly to a remote user. For example, the processor of the pet treat dispensing device 100 may cause the camera data to be sent to an owner via email, a web interface or a mobile application.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A pet treat dispensing device, comprising:
a main housing having an outlet opening; and
a treat dispensing portion disposed in the interior of the main housing, including:
a base;
a dispensing chamber configured to rest on at least a portion of the base, the dispensing chamber having a first opening; and
a dispensing turbine configured to rotate horizontally within the dispensing chamber, the dispensing turbine including:
a turbine hub; and
at least one blade attached to a lateral surface of the turbine hub,
wherein the first opening of the dispensing chamber is generally aligned with the outlet opening.

2. The device of claim 1, wherein the dispensing turbine is configured to rotate within a cylindrical bore of the dispensing chamber, the cylindrical bore extending between a top surface of the dispensing chamber and a bottom surface of the dispensing chamber, and wherein the first opening of the dispensing chamber extends between a wall of the cylindrical bore and an outer surface of the dispensing chamber.

3. The device of claim 1, further comprising a camera coupled to the main housing, wherein the camera is configured to transmit camera data captured by the camera to a user.

4. The device of claim 1, further comprising a vertical shaft positioned on a top surface of the base, the vertical shaft being rotatable with respect to the base, wherein the turbine hub has an axial bore extending from a bottom surface of the turbine hub, the axial bore sized to fit over the vertical shaft.

5. The device of claim 4, wherein rotation of the dispensing turbine is caused by rotation of the vertical shaft with respect to the base when the turbine hub is fit over the vertical shaft.

6. The device of claim 4, further comprising an electric motor configured to drive rotation of the vertical shaft.

7. The device of claim 1, wherein the dispensing chamber is removable from the main housing.

8. The device of claim 2, wherein the turbine hub has a conical shape and wherein a diameter of a bottom surface of the turbine hub is substantially equal to a diameter of a bottom end of the cylindrical bore.

9. The device of claim 2, wherein the at least one blade comprises a projection extending radially outward from the lateral surface of the turbine hub and wherein a width of the projection increases in a radial direction towards the wall of the cylindrical bore.

10. The device of claim 1, further comprising a dispensing chute, the dispensing chute having a first end, a second end and a ramp extending between the first end and the second end, wherein the first end of the chute is in communication with the first opening of the dispensing chamber.

11. The device of claim 10, further comprising an infrared emitter and an infrared detector positioned on the ramp of the dispensing chute.

12. A method for dispensing a pet treat, comprising:
providing a pet treat dispensing device including a camera;
capturing a first image using the camera;
based on the first image, determining that a pet is within a field of view of the camera;
in response to determining that the pet is within the field of view of the camera:
causing the pet treat dispensing device to provide an audible signal to summon the pet; and
starting capture of camera data using the camera;
based on the captured camera data, determining that a first condition is satisfied; and
in response to determining that the first condition is satisfied:
causing the pet treat dispensing device to dispense a treat.

13. The method of claim 12, wherein the pet treat dispensing device comprises:
a main housing having an outlet opening;
a treat dispensing portion disposed in the interior of the main housing, including:
a base;
a dispensing chamber configured to rest on at least a portion of the base, having:
a cylindrical bore adapted to receive pet treats, the cylindrical bore extending between a top surface of the dispensing chamber and a bottom surface of the dispensing chamber; and
a first opening extending between a wall of the cylindrical bore and an outer surface of the dispensing chamber;
a dispensing turbine configured to rotate horizontally within the cylindrical bore, the dispensing turbine including:
a turbine hub; and
at least one blade coupled to a lateral surface of the turbine hub, the at least one blade configured to fit between the lateral surface and the wall of the cylindrical bore; and
an electric motor configured to drive rotation of the dispensing turbine,
wherein the first opening of the dispensing chamber is in communication with the outlet opening.

14. The method of claim 12, wherein determining that a pet is within a field of view of the camera comprises executing a computer vision algorithm on a processor of the pet treat dispensing device to determine whether a subject identified in the first image is a pet.

15. The method of claim 12, wherein determining that a first condition is satisfied comprises detecting that the pet is within a predetermined distance of the pet treat dispensing device.

16. The method of claim 13, wherein causing the pet treat dispensing device to dispense a treat comprises causing the electric motor to rotate the dispensing turbine.

17. The method of claim 16, further comprising detecting whether a jam of the dispensing turbine has occurred.

18. The method of claim 17, wherein detecting whether a jam of the dispensing turbine has occurred comprises using one or more infrared sensors in the pet treat dispensing device to determine whether a treat has already been dispensed.

19. The method of claim 12, wherein causing the pet treat dispensing device to dispense a treat comprises transmitting a command to control the pet treat dispensing device via an electronic device.

20. The method of claim 16, further comprising causing the electric motor to rotate the dispensing turbine in a reverse direction when a jam of the dispensing turbine is detected.
